(19) United States
(12) Patent Application Publication
(10) Pub. No.: US 2009/0181241 A1
(43) Pub. Date: Jul. 16, 2009

(54) Method Of Making Glossy Ink Jet Media Using Sub-Micron Silica Coating And Calendering Process

(76) Inventor: Yaoliang Hong, Mason, OH (US)

Correspondence Address: INTERNATIONAL PAPER COMPANY, 6285 TRI-RIDGE BOULEVARD, LOVELAND, OH, 45140, US

(21) Appl. No.: 12/352,257

(22) Filed: Jan. 12, 2009

Related U.S. Application Data
(62) Division of application No. 10/638,417, filed on Aug. 12, 2003.

(51) Int. Cl. B32B 5/16; B32B 29/00; C01B 33/12; B05D 3/12

(52) U.S. Cl. 428/331; 428/452; 428/341; 423/335; 427/361

(57) ABSTRACT

The invention relates to instant drying glossy ink jet media made by using a sub-micron silica coating and a calendering process, preferably a supercalendering process.

### FIELD OF THE INVENTION

The invention relates to instant drying glossy ink jet media using a sub-micron silica coating and a calendering process, preferably a supercalendering process.

### BACKGROUND OF THE INVENTION

With the rapid increase in ink jet printing, the demand for instant drying glossy ink jet media for high-end photo application has increased. Instant drying glossy ink media are usually made by applying a thick glossy microparticle coating layer onto a resin-coated base paper, or by specialty coating processes, such as cast coating. For example, U.S. Pat. No. 6,110,585 describes a method of making glossy ink jet media by applying multi-layer (four layers) coatings onto a resin coated photographic paper substrate. U.S. Pat. No. 6,187,430 describes a method of making glossy ink jet media by using fine (colloidal) silica with an average primary particle size of 3 to 40 nm and a cast coating process. Cast coating usually requires a matte coated paper as a substrate for good ink jet printing performance. The known methods for producing instant drying glossy ink jet media are expensive due to the expensive substrate, coating material, and/or specialty coating process, especially when making two-side coated media.

The combination of using sub-micron silica and calendering process in the present invention is nowhere disclosed nor suggested by the art discussed.

It is one objective of the invention to produce instant drying glossy ink jet media having one or both sides coated with a sub-micron silica coating.

It is another objective of the invention to produce instant drying glossy ink jet media by using a sub-micron silica coating and a calendering process.

It is yet another objective of the invention to provide a low cost method for producing instant drying glossy ink jet media.

These and other objects of the invention will become apparent to one of ordinary skill in the art after reviewing the disclosure of the invention.

### SUMMARY OF THE INVENTION

Sub-micron silica coatings are applied to low cost, uncoated substrates (media). One or both sides of the uncoated substrates can be coated. Following the coating process, the coated substrates undergo a calendering process to achieve surface gloss while maintaining ink jet printability. The resulting media are suitable for special ink jet applications such as the production of brochures and flyers, greeting cards, and photo album papers.

### BRIEF DESCRIPTION OF THE DRAWING

FIG. 1 is a cross-section of the ink jet media described in the present invention.

### DETAILED DESCRIPTION OF THE INVENTION

A sub-micron silica layer functions as an ink jet-receiving layer. The size of the silica particles and the micropores inside the sub-micron silica particles are important to generate surface gloss and maintain ink absorption capability. The sub-micron silica particles have a particle size below 1 micron and preferably about 0.3 microns. The coating contains latex binder(s) and other additives in addition to the sub-micron silica, to form a porous coating layer. The porous coating layer helps to generate the surface gloss after calendering. The micropores inside the sub-micron silica particles will not be fully compressed or collapsed after calendering. The coating layer therefore can maintain enough ink absorption capability for ink jet printing.

Calendering is preferably accomplished by supercalendering at temperatures ranging from 60° F. to 200° F., and preferably from 90° F. to 150° F. The nip pressure can range from 300 PLI to 3000 PLI, and the preferred range is 800 PLI to 2000 PLI. Lastly, the speed of the supercalendering can range from 20 to 3000 feet per minute, and is preferably 100 to 2000 feet per minute. Other calendering methods such as soft-nip calendering or shoe-nip calendering can be used.

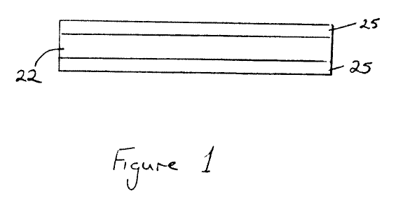

The sub-micron silica coating 25 is applied to an uncoated substrate 22. The coating can be applied by known coating processes such as slot die, rod and curtain coating. The low cost of the uncoated substrate and high coating speed help to keep the production cost of the ink jet media at a low level. The coating formulation includes sub-micron silica, polymer binder(s) and other additives, such as surfactants to achieve wettability during the coating process. The cross-section of the resultant ink jet media is shown in FIG. 1.

An example of the method of making the glossy ink jet media by this invention is described. Seventy parts (dry parts, same below) of sub-micron silica, under the name SyloJet 703C (18.5% solids, 0.3 micron particle size), available from Grace Davison, Baltimore, Md., is weighed and mixed with 30 parts of Acrit RKW-319SX, a cationic acrylic copolymer emulsion with 30% solids from Taisei Chemical Industries, Ltd. (Katsushika-ku, Tokyo, Japan) as a binder, and one part of a nonionic surfactant, octylphenoxypolyethoxyethanol (under the name Triton X-100 surfactant from formerly Union Carbide Corporation, now Dow Chemical, Danbury, Conn.). The coating fluid is applied to an uncoated paper such as Hammermill Color Copy Cover 80# which is produced by International Paper. The coating is applied to assure a dry coat weight between 10 to 30 g/m². The coated paper is supercalendered at a temperature of 90° F., a speed of 150 feet per minute, and a nip pressure of 2000 PLI. The resultant sheet has a glossy surface and good ink jet recording performance. Moreover, the sheet demonstrates good surface scratch resistance.

The coating composition can be varied. Specifically, the ratio of the sub-micron silica to the binder such as the cationic acrylic copolymer emulsion, synthetic cationic polyurethane and poly (vinyl alcohol) can be changed for different ink absorption capacities. Some additives such as glycerol and polyethylene glycol can be added as plasticizers. Substrates such as uncoated papers with different sizing levels and calipers can also affect ink absorption capability so that the coating composition and the coat weight can be adjusted accordingly. Other substrates such as matte coated papers, synthetic papers or microporous films can also be used. The temperature, speed and pressure of the supercalendering process can be managed to achieve different levels of surface gloss and ink absorption capability.

The resultant media have the advantage of glossy finish and ink absorption. For comparison, media coated with micron sized silica may have good ink absorption, however the surface of the media can not become glossy after calendering since the size of the silica particles is too big.

The following comparative examples are described to show the relationship between sub-micron silica and its beneficial property—surface gloss does not exist for silica of larger particle size. For comparison, the particle size of the sub-micron silica as described above is 0.3 microns, and the particle sizes of the two silicas as described below are 3 and 12 microns, respectively.

### COMPARATIVE EXAMPLE 1

SyloJet P403 (silica powder, 3 micron particle size) from Grace Davison is dispersed to a silica slurry with 16% solids by using high shear mixer and a silica dispersant (0.5 wt % based on dry silica) such as DisperBYK-190 from BYK Chemi USA, Wallingford, Conn. Seventy parts (dry parts, same below) of the SyloJet P403 slurry is weighed and mixed with 30 parts of Acrit RKW-319SX from Taisen Chemical Industries, Ltd., and one part of Triton X-100 surfactant from Dow Chemical. The coating liquid is applied to an uncoated paper such as Hammermill Color Copy Cover 80# with dry coat weight between 10 to 30 g/m2. The coated paper is supercalendered at a temperature of 90^{>}F, a speed of 150 feet per minute, and a nip pressure of 2000 PLI. The resultant sheet is matte (no surface gloss).

DisperBYK-190 is a solution of high molecular weight, polyfunctional block copolymer with anionic/non-ionic character. It has pigment affinic groups. The vendor does not disclose the generic name.

### COMPARATIVE EXAMPLE 2

The SyloJet P412 (silica powder, 12 micron particle size) is used to replace SyloJet P403 in the Comparative Example 1. The resultant sheet is matte after the supercalendering process.

While the invention has been described with references to a preferred embodiment, variations and modifications would be obvious to one of ordinary skill in the art and the invention encompasses such variations and modifications.

I claim:

1. An ink jet media, comprising:
a substrate,
a sub-micron silica coating on at least one side of said substrate, and
said coating applied to said substrate, followed by a calendering process.

2. The ink jet media of claim 1, wherein the particle size of the sub-micron silica is 0.3 microns.

3. The ink jet media of claim 1, wherein said substrate is paper.

4. The ink jet media of claim 1, wherein said coating is applied to both sides of said substrate.

5. The ink jet media of claim 1, wherein said coating has a dry coat weight of 10 to 30 g/m².

6. The ink jet media of claim 1, wherein said coating comprises sub-micron silica and a polymer binder.

7. The ink jet media of claim 1, wherein said coating is applied to said substrate, followed by supercalendering the ink jet media at a temperature ranging from 60° F. to 200° F., a speed ranging from 20 to 3000 feet per minute and a nip pressure ranging from 300 to 3000 PLI.

8. The ink jet media of claim 1, wherein the calendering process is shoe-nip calendering or soft-nip calendering.

9. A method of making ink jet media, comprising:
providing a substrate,
applying a sub-micron silica coating to at least one side of said substrate, and
calendering the ink jet media.

10. The ink jet media of claim 9, wherein the particle size of the sub-micron silica is 0.3 microns.

11. The method of claim 9, wherein said substrate is paper.

12. The method of claim 9, further comprising applying the coating to both sides of said substrate.

13. The method of claim 9, further comprising applying the coating to have a dry coat weight of 10 to 30 g/m².

14. The method of claim 9, wherein said coating comprises sub-micron silica and a polymer binder.

15. The method of claim 9, wherein said calendering is supercalendering at a temperature ranging from 60° F. to 200° F., a speed ranging from 20 to 3000 feet per minute and a nip pressure ranging from 300 to 3000 PLI.

16. The ink jet media of claim 9, wherein the calendering process is shoe-nip calendering or soft-nip calendering.
